(19) United States
(12) Patent Application Publication
(10) Pub. No.: US 2008/0000956 A1
(43) Pub. Date: Jan. 3, 2008

(54) Safety inserter loader

(76) Inventor: William Alan Collins, Piqua, OH (US)

Correspondence Address: William Alan Collins, P.O. Box 1643, Piqua, OH, 45356, US

(21) Appl. No.: 11/430,629

(22) Filed: May 9, 2006

(51) Int. Cl. B65G 11/04

(52) U.S. Cl. 232/44

(57) ABSTRACT

A thin flat door 1 can be opened up at the scored line 10 putting the card 7 in next to the stem 4 will guide it. The back 2 is there for added support. The door has a flap 11 it is attached to stem. Use the notch 6 to catch the sleeve 8 edge for no side to side movement.

Operating this Loader, you will then push 9 card down with finger, holding onto the hold tab 5. By gently pulling on the pull tab 3 and at the same time holding onto the sleeve, remove Loader.

### FEDERALLY SPONSORED RESEARCH

Not Applicable

### SEQUENCE LISTING OF PROGRAM

Not Applicable

This invention relates to the field of card collecting and the card collectors personal investment in their value. And . . . inserting cards in protective sleeves.

### BACKGROUND OF INVENTION

1. Prior Art

I offer a safe way to insert a card with a firm and non damaging procedure. The introduction to today's plastic sleeves on the market leads me to think why did they not make an accompanying device at the time.

Doing the job alone (inserting a card by hand) is in a lot of ways, a very cumbersome way to preform this task.

You may bend the card while inserting it by hand alone. A nicer looking card can bring a better price. Ridged plastic and flimsy plastic sleeves are two different but similar products, preforming the same job. My Safety Loader is made for both types of plastics.

The plastic (sleeve) needs more guidance, direction. A thin, almost transparent sleeve looks almost invisible.

Here are some of the disadvantages:
A.) You can bend a card while inserting it by hand alone.
B.) You may have a shaky hand, this could bend a corner.
C.) A clear plastic holder alone seems transparent, invisible.

2. Objects and Advantages

Accordingly, besides the objects and advantages of the Safety Inserter Loader described in the above, patent application, several objects and advantages of the invention are:
A.) Lightweight, easy to handle.
B.) Waterproof.
C.) This item is for right handed and left handed persons.
D.) People with disabilities and others with limited use of their extremities.
E.) It is much faster to load a card with this item, less effort involved.
F.) The age of the customer is from the very young to the experienced card collector.
G.) Use all year round.

### SUMMARY

In accordance with the present invention, the Safety Inserter Loader comprises of a flat, clear plastic door.

A stem of thin plastic (for guidance). A back made of a solid bright color to complete the sandwich effect. I need to mention the fact my invention has working parts. I understand the word generic, I think those protective sleeves fall into that category.

The door is clear, lets the person have an unobstructed view of the card. The back is a solid color, this gives the appearance of more integrity.

I made this loader to accommodate both types of sleeves, the thin and flimsy type and the hard ridged kind.

A person who does this job (inserting cards) daily, a card shop owner for instance, may use this Loader. It is quicker, so it will save time.

### DRAWINGS—FIGURES

FIG. 1 Front view.

FIG. 2 Back view.

FIG. 3 Side view.

FIG. 4 Card is introduced.

FIG. 5 Door is closed on card.

FIG. 6 Card is introduced to protective sleeve.

FIG. 7 Shown where to push card with finger.

FIG. 8 Card is inserted, remove loader.

FIG. 9 Door standing alone. The score line or (hinge) is next to flap. The flap is attached to outer edge of stem.

FIG. 10 Back section standing alone. The stem will be incorporated into this section as one.

FIG. 11 The card and the measurements given are the average size known to the card market.

FIG. 12 Right handed version of Loader.

FIG. 13 Left handed version of Loader.

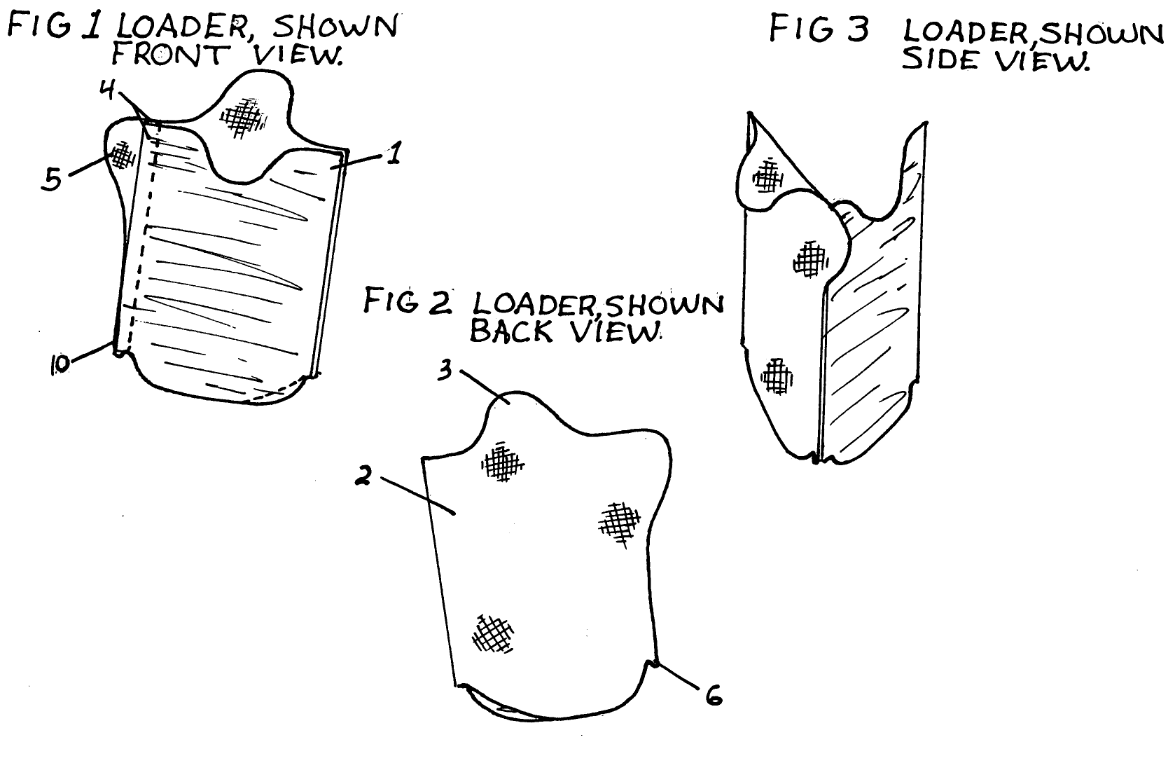

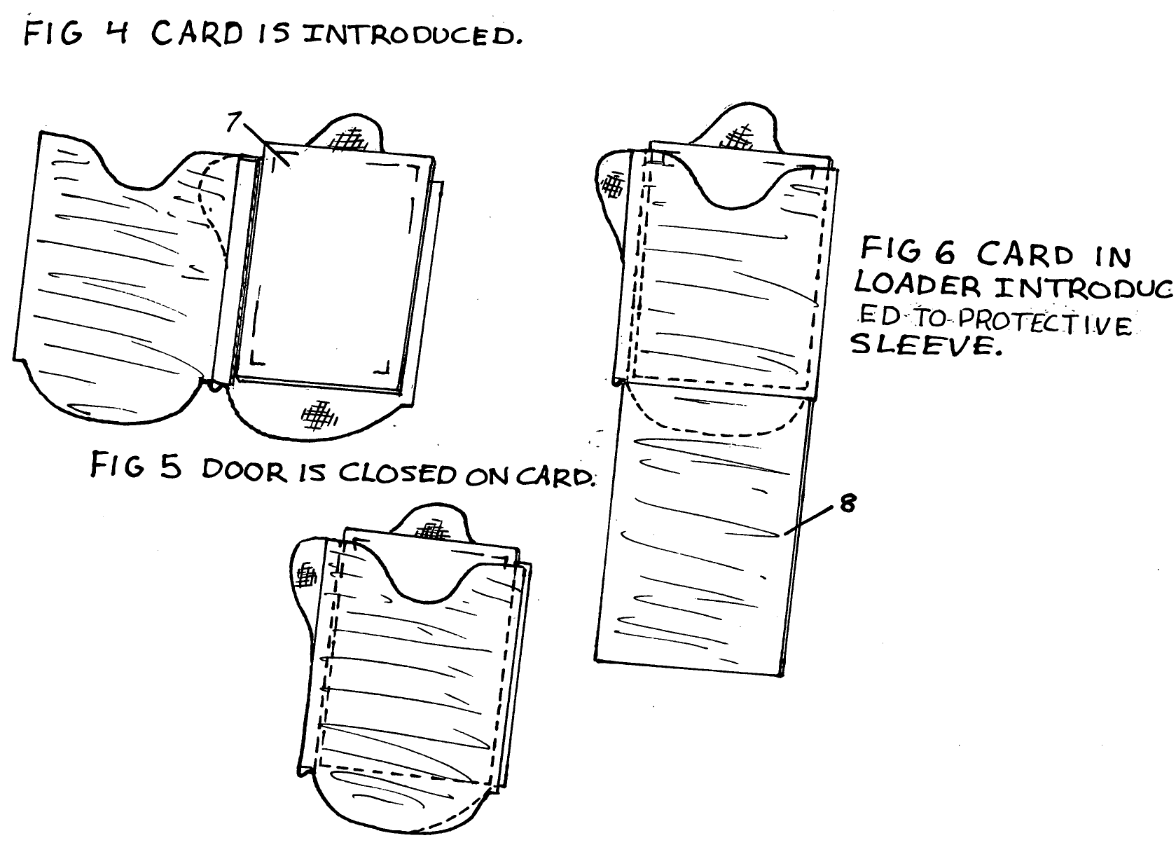

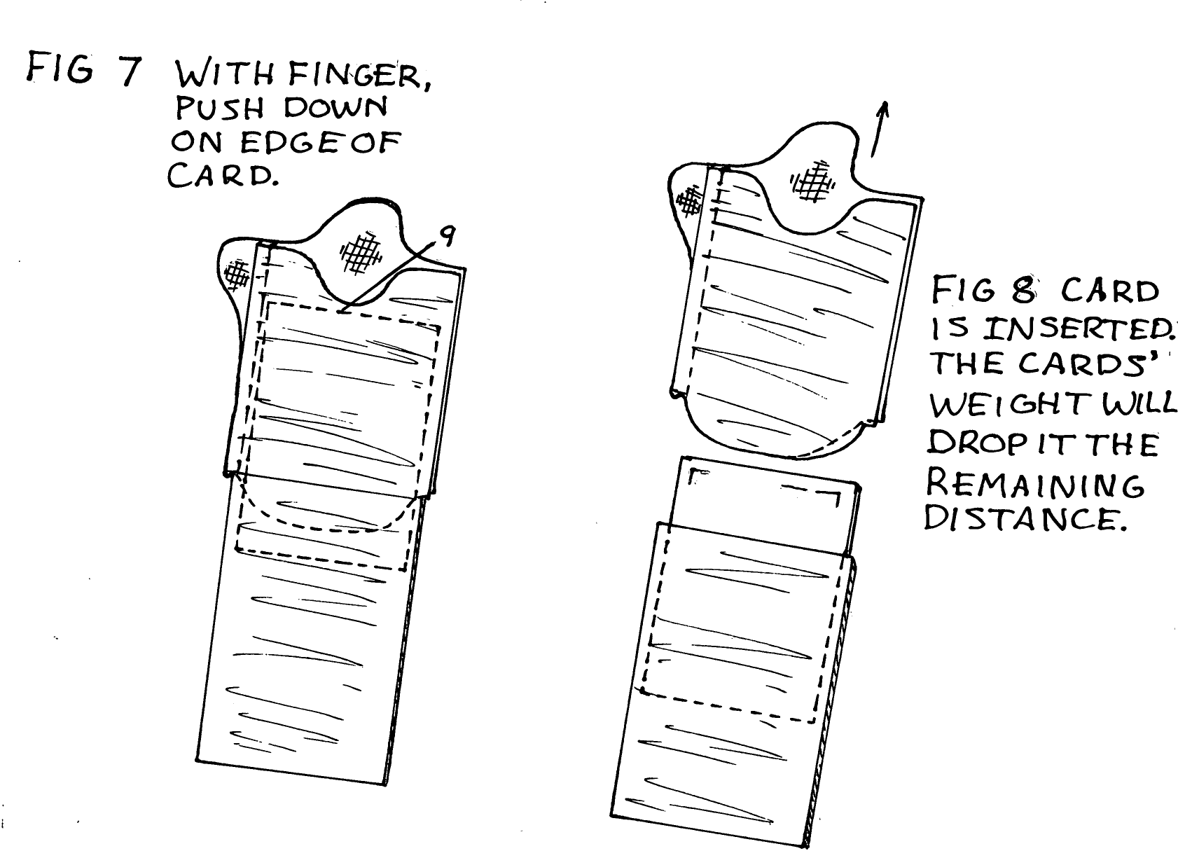

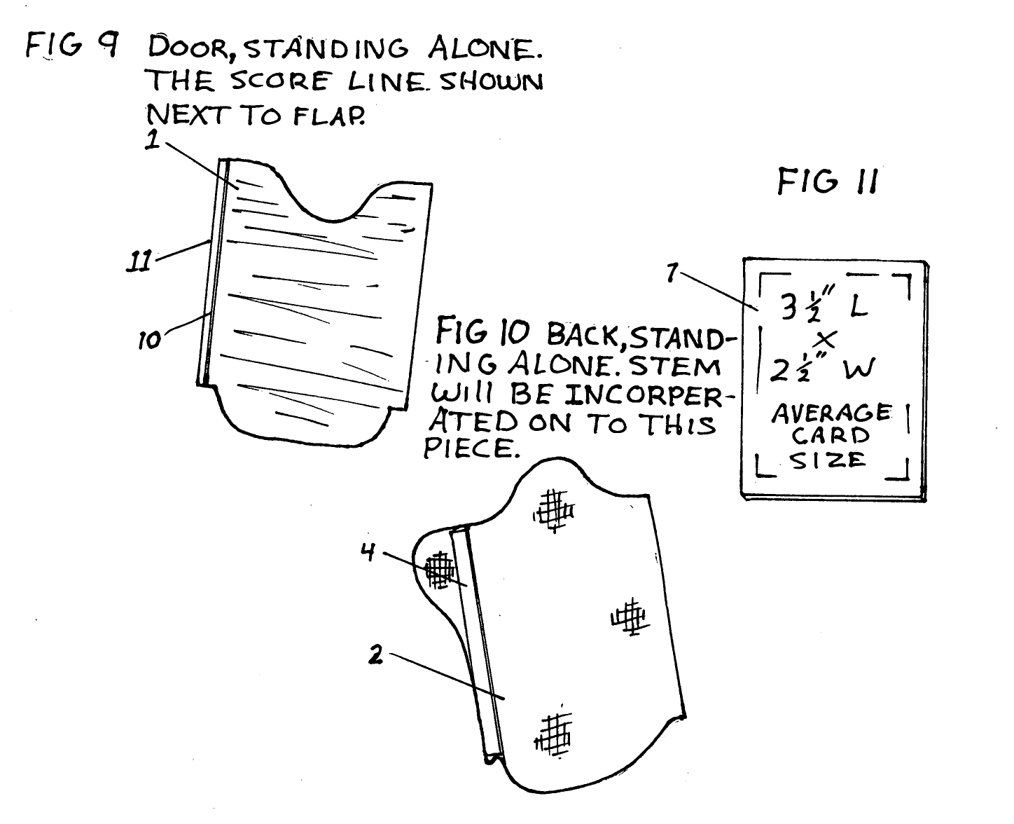

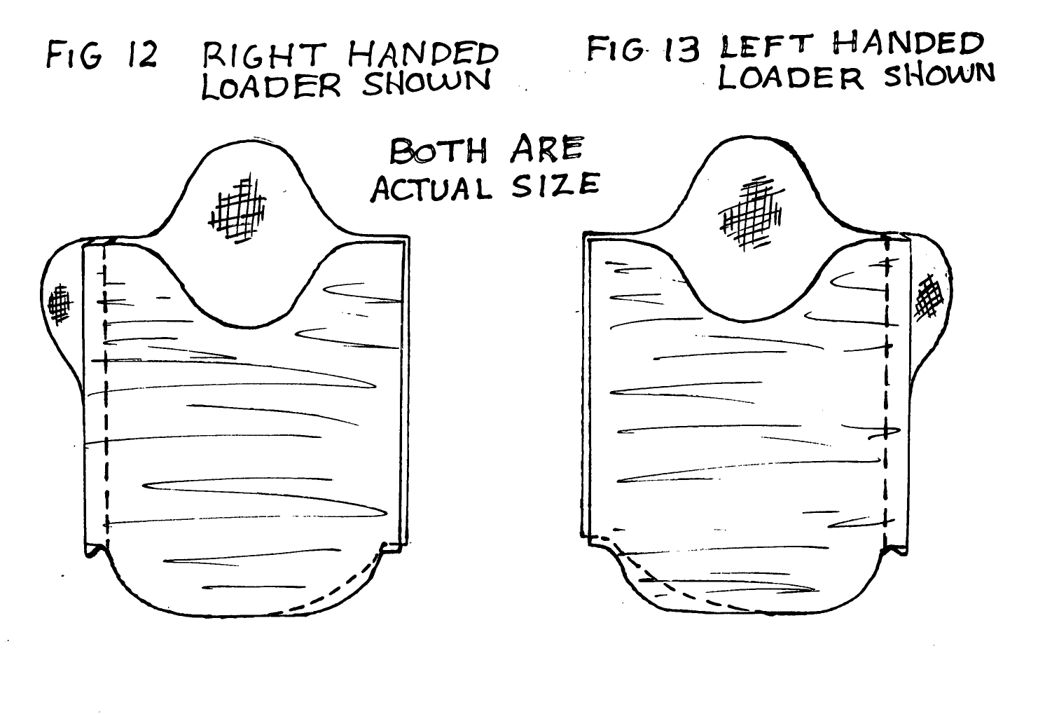

### DRAWINGS—REFERENCE NUMERALS

1.) Door
2.) Back
3.) Pull tab
4.) Stem
5.) Hold tab
6.) Notch
7.) Card
8.) Protective sleeve
9.) Area to push card
10.) Score line in door
11.) Flap

The door hinge will be a scored line at edge of stem, the remaining flap will be attached on outer edge of stem. The scored door approach will give the single handed user, ease to flip open.

### DRAWINGS—SEPARATED AND INDIVIDUAL PARTS

FIG. 9 Door lying flat shows score line and the flap.

FIG. 10 Stem will be incorporated with loader back section for smooth and non obstructive function.

FIG. 11 Universal size of card:
3½ in. long, 2½ in. wide

1.) The safety inserter loader gives the user a guarantee their card will be loaded safe.

2.) The colors chosen in the loader functions will give problem free operation.

3.) Guidance of the card is paramount when storing a card.

4.) Investment in card collecting grows.

5.) The best loaded card will command a greater sense of satisfaction.

6.) In the future, when this item becomes more popular, a larger, thicker version can be made for thick cards.

7.) This product will arouse a greater demand in protective sleeves.
